(19) United States
(12) Patent Application Publication
(10) Pub. No.: US 2013/0226686 A1
(43) Pub. Date: Aug. 29, 2013

(54) CUSTOMER LOYALTY IDENTIFICATION MATCHING

(71) Applicant: Glenn Grossman, Matthews, NC (US)

(72) Inventor: Glenn Grossman, Matthews, NC (US)

(73) Assignee: BANK OF AMERICA CORPORATION, Charlotte, NC (US)

(21) Appl. No.: 13/407,544

(22) Filed: Feb. 28, 2012

(51) Int. Cl. G06Q 30/02

(52) U.S. Cl. 705/14.27

(57) ABSTRACT

Embodiments of the invention are directed to a system, method, or computer program product for loyalty identification matching. Embodiments of the invention reduce the friction of enrolling in and providing loyalty accounts and coupons at a point-of-transaction for a transaction with a merchant. Once the user enrolls in the program, all loyalty accounts the user may have are determined. Furthermore, coupons that are available to the user are determined and stored in association with the user's loyalty accounts. In this way, the user may provide a user identifier to the merchant at a point-of-transaction to utilize the user's loyalty accounts and/or coupons for the transaction. The system, after receiving the user identifier from the merchant may provide the merchant with all loyalty accounts and coupons associated with the transaction the user is entering into with the merchant and apply them to the transaction.

### BACKGROUND

An individual regularly receives promotional offers, coupons, loyalty rewards, and/or the like in order to entice an individual to shop at a particular merchant or location. These offers may come to the individual through the mail, email, the Internet, the newspaper, flyers, and the like. Most of the time the offers received by the individual go unused. This may be because the individual does not take the time to cut-out or print-off the offer, find an offer that he/she wants to use, cuts-out the offer but fails to use it, or the individual may not even look at the offers he/she receives.

The individuals that do take the time to look through all the offers they receive and utilize the offers at merchants tend to save significant amounts of money on transactions for products that are associated with the offers. The offers provided for products may add up to substantial savings for the individuals that take advantage of the offers that they receive.

However, typically the offers that an individual may use are few in comparison to the amount of offers that are potentially available for a product, brand of product, or type of product. For example, an individual may receive a coupon in a newspaper, cut out the coupon and use it to purchase a product. However, there may be other promotional offers that the individual may not be aware of, such as a promotional offer on the Internet that may be a better deal for the individual. In this way, the individual may miss a promotional offer, because he/she was unable to find the offer.

Therefore, a need exists for individuals to be able to find and utilize offers without having to search for, cut-out, and bring with him/her to the merchant in order to receive the benefit of the offer.

### BRIEF SUMMARY

The following presents a simplified summary of all embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of all embodiments in a simplified form as a prelude to the more detailed description that is presented later.

Embodiments of the present invention address the above needs and/or achieve other advantages by providing apparatus (e.g., a system, computer program product and/or other devices) and methods for providing loyalty identification and coupon matching for a user. Thus, loyalty accounts and coupons may be utilized by a user during a transaction using a simple identification of the user. This way eliminating the need to carry keychain loyalty cards or coupons to the point-of-transaction.

In some embodiments, the system may receive an indication that a user may wish to enroll in the loyalty identification matching program. The user may enroll by manually providing the system with enrollment information. The user may also enroll automatically based on the user's prior enrollment in other programs provided by merchants, financial institutions, and/or other entities that may be providing the loyalty identification matching program.

Next, the system may receive user enrollment data from the user which may include the user identifier. The user identifier may include the user's phone number, PIN number, password, and/or the like. Furthermore, the system may determine all of the loyalty accounts the user currently has. In this way, the system may determine the loyalty accounts by user provided data, by communicating with merchants, and/or the like.

In some embodiments, the system may then populate the user's loyalty database with all the loyalty accounts that the system has determined are associated with the user. The user's loyalty accounts are determined by the user's enrollment information and the system communicating with several merchants to determine the loyalty accounts associated with the user.

In some embodiments, once all of the user's loyalty accounts are stored with the user enrollment data the system may determine coupons the user may be able to utilize for transactions with merchants the user has loyalty accounts with. In this way, the system may receive coupons from merchants, user inputted coupons, manufacturers, advertisers, etc. and tie the coupons to the loyalty accounts the user has. In some embodiments, the coupons are based on the loyalty accounts the user has. In other embodiments, the coupons are based on the products the user is transacting with a merchant to purchase.

In some embodiments, the system may provide a merchant with the user's loyalty account and coupons in response to the user providing the merchant with a user identifier, such that the transaction may incorporate the user's loyalty account and/or coupons. In this way, the user may be able to provide a simple user identifier without having to provide a loyalty account card, cut-out coupons, or the like to utilize his/her loyalty account and/or coupons. In this way, the invention reduces friction associated with the user having to enroll in and utilize loyalty accounts by providing keychain cards, etc. to the merchant.

In some embodiments, if the user is attempting to transact with a merchant that the user does not have a loyalty account with, the system may offer the user automatic enrollment in the loyalty account associated with the merchant the user is attempting to transact with. In this way, the user may be able to automatically enroll in loyalty accounts and utilize coupons that the user may not have been able to utilize for that transaction because he/she was not a loyalty account holder for that merchant.

Embodiments of the invention relate to systems, methods, and computer program products for providing loyalty account information, comprising: receiving an enrollment indication for a user, wherein the enrollment indication comprises a user identifier; determining loyalty accounts associated with the user, wherein the loyalty accounts are determined by communicating with merchants providing the loyalty accounts, wherein the loyalty accounts are then stored in association with the user identifier; receiving a communication from a merchant comprising the user identifier, wherein the communication is part of transaction with the merchant; matching the user identifier communicated from the merchant with the loyalty accounts associated with the user identifier; determining if the loyalty accounts associated with the user identifier received from the merchant are accepted by the merchant; and providing the merchant with the loyalty accounts accepted by the merchant, such that the loyalty accounts can be applied to the transaction with the merchant.

In some embodiments, the invention further comprises: determining coupons available to the user; storing the coupons in association with the user identifier and the loyalty accounts; determining coupons that the merchant of the transaction accepts; and providing the merchant with the coupons acceptable by the merchant in association with the loyalty accounts accepted by the merchant, such that the coupons and loyalty accounts can be applied to the transaction with the merchant.

In some embodiments, the enrollment indication is automatically provided based at least in part on the user previously enrolling in another program, wherein the another program is provided by one or more of the merchant or a financial institution. Furthermore the user identifier is a unique identifier of a user, wherein the user identifier is a telephone number associated with the user.

In some embodiments, determining loyalty accounts associated with the user further comprises receiving loyalty account information from one or more of the user or the merchant. Determining coupons available to the user further comprises receiving coupons from one or more of the merchant offering the coupons or the user. In some embodiments, the transaction is at a physical point-of-transaction of the merchant.

In some embodiments, the invention further comprises providing automatic enrollment in one or more loyalty accounts associated with the merchant if no loyalty accounts associated with the user identifier received from the merchant are accepted by the merchant.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating a loyalty identification matching program process, in accordance with one embodiment of the present invention;

FIG. 2 provides a loyalty identification matching program system environment, in accordance with one embodiment of the present invention;

FIG. 3 provides a process map illustrating the population of the loyalty identification matching program system, in accordance with one embodiment of the present invention;

FIG. 4 provides a process map illustrating populating of the loyalty identification matching program system, in accordance with one embodiment of the present invention;

FIG. 5 provides a process map illustrating enrollment options for the loyalty identification matching program, in accordance with an embodiment of the invention; and

FIG. 6 provides a illustrating the loyalty identification matching program being used for a merchant transaction, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Furthermore, as used herein, the term “product” shall mean any good, service, event, etc. that may be offered by an advertiser. In addition, the term “offer” or “promotional offer” is used herein to denote any form of offer, promotion, rebate, coupon, incentive, sale event, and/or the like offered for the purchase, lease, and/or the like of a product. A “merchant” as used herein may refer to an advertiser, manufacturer, retailer, merchant, service provider, event provider, warehouse, supplier, commercial partner of a financial institution, and/or the like.

Although some embodiments of the invention herein are generally described as involving a “financial institution,” one of ordinary skill in the art will appreciate that other embodiments of the invention may involve other businesses that take the place of or work in conjunction with the financial institution to perform all of the processes or steps described herein as being performed by a financial institution. Still in other embodiments of the invention the financial institution described herein may be replaced with other types of businesses that are in the position to provide loyalty identification matching.

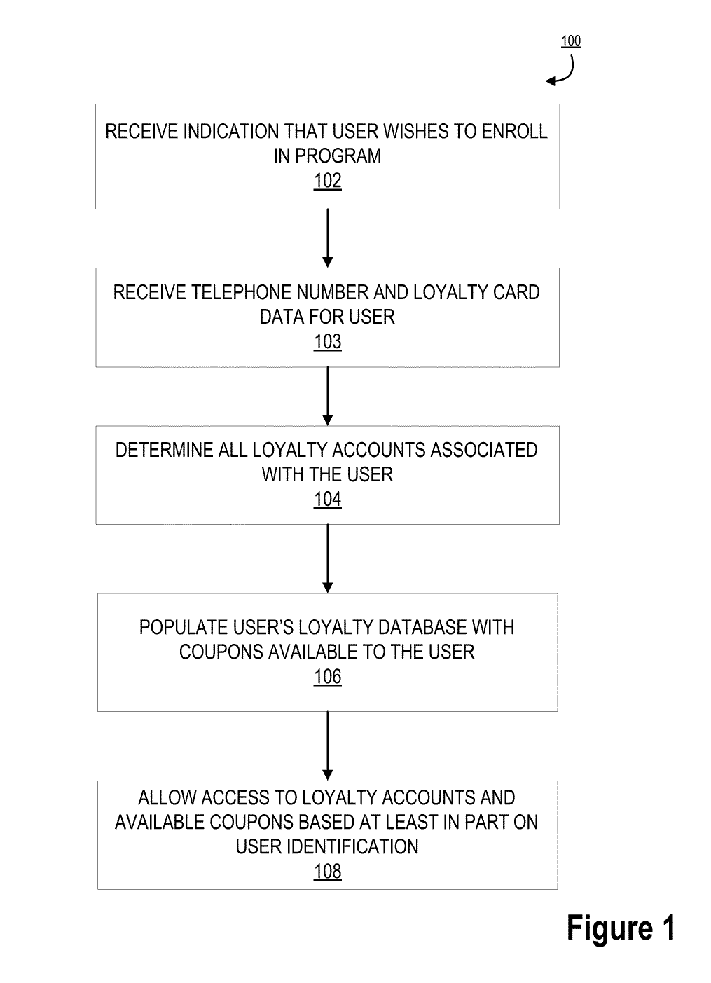

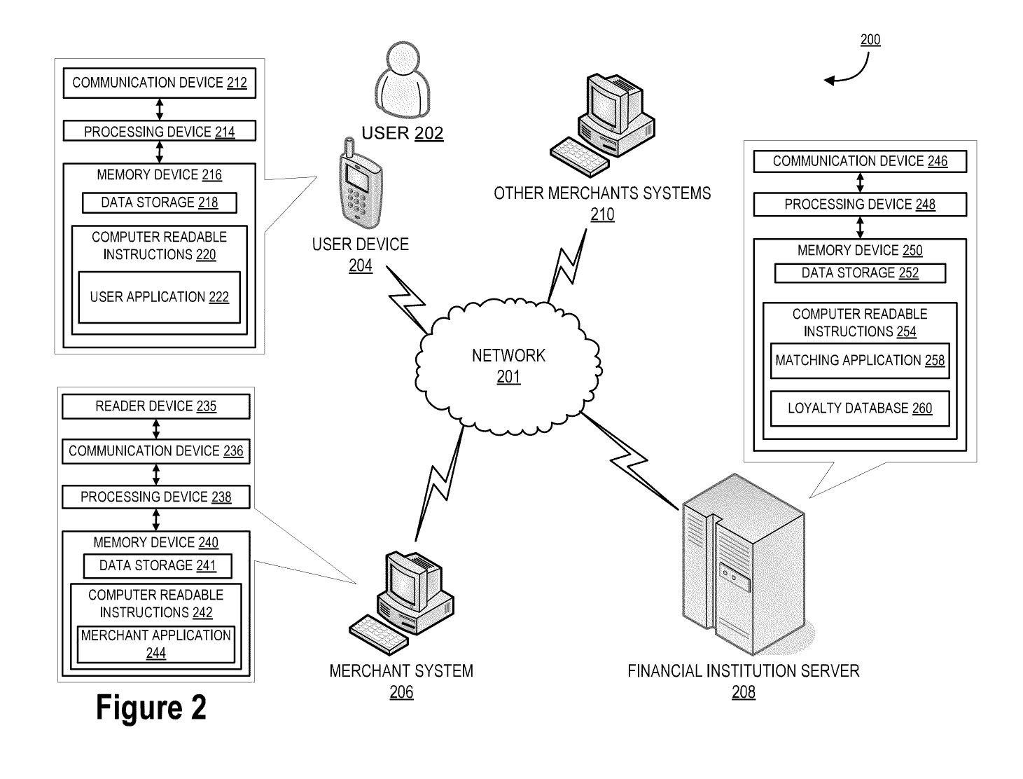

FIG. 1 illustrates a high level process flow for the loyalty identification matching program 100, which will be discussed in further detail throughout this specification with respect to FIGS. 2 through 6. The first step in the process 100 is to receive an indication that the user wishes to enroll in the loyalty identification matching program, as illustrated in block 102. In some embodiments, the enrollment may be initiated by the user. In other embodiments, the enrollment may be initiated by the program. The next step in the process 100 is to receive a telephone number and loyalty card data for the user 103. In some embodiments, the system may access and acquired the user's telephone number and loyalty card data independent of user input. Loyalty card data may include any data that a merchant or other entity may require in order for a user to set up and activate a loyalty account with the merchant, this data may include, but is not limited to a user's telephone number, address, financial data, birth date, etc. In this way, the system may have access to information about the user, such as his/her telephone number, address, etc. that may be included as loyalty card data, based on other programs the user may have with the entity providing the program.

Next, in block 104, the system determines all the loyalty accounts associated with the user. In some embodiments, the loyalty accounts associated with the user may be determined from the system communicating with merchants providing loyalty accounts. In this way, the system may reach out to merchants that provide loyalty accounts and determine all of the merchants that the user has loyalty accounts with. In other embodiments, the loyalty accounts associated with the user may be determined by user inputs. In this way, the user may provide information associated with the loyalty accounts the user has with various merchants. Once the system has determined all the loyalty accounts associated with the user and stored the information in a user director, the system may populate the user's loyalty accounts located within the directory with coupons available to the user, as illustrated in block 106. In this way, coupons available to the user may be accessed via the user's loyalty account. For example, if a user is transacting with a merchant, the user may present his/her loyalty card. The loyalty card may be scanned by the merchant to associate the transaction with the user's loyalty account. By populating the loyalty account associated with the user with coupons, these coupons may be automatically applied to the user's transaction at the merchant. In this way, the user may not have to provide cut-out, printed, etc. coupons at the point-of-transaction, but instead just provide the loyalty account. The loyalty account may store the coupons and provide them to the merchant at the point of transaction. Finally, as illustrated in block 108 the system allows a merchant to gain access to the user's loyalty account and the coupons stored therewith based on the user provided identification. The user provided identification may include the user's phone number, PIN number, code, password, etc. In this way, the user does not have to provide a keychain card, loyalty card, etc. at the point of transaction, but instead only provide the merchant with a user identification, such as a telephone number.

FIG. 2 provides a loyalty identification matching program system environment 200, in accordance with one embodiment of the present invention. As illustrated in FIG. 2, the financial institution server 208 is operatively coupled, via a network 201 to the user device 204, to a merchant system 206, and to other merchants systems 210. In this way, the financial institution server 208 can send information to and receive information from the user device 204, the merchant system 206, and to other merchant systems 210 to allow a user 202 to enroll in the loyalty identification matching program, collect enrollment information from the user 202, populate the loyalty accounts and user 202 enrollment data into a user loyalty database, match coupons to the users database, provide user 202 identify confirmation to a merchant, and provide loyalty and coupon data for a transaction. FIG. 2 illustrates only one example of an embodiment of a loyalty identification matching program system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual. The individual may be an account holder at the financial institution or not associated with the financial institution. The individual may wish to purchase products at a merchant, on-line, via a virtual shopping board, and/or the like, utilizing the loyalty accounts provided to the individual from a merchant.

As illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are located between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the user device 204, the merchant system 206, and the other merchants systems 210. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of a matching application 258. In another embodiment, the computer-readable instructions 254 stored in the memory device 250 includes the computer-readable instructions 254 of a loyalty database 260. In some embodiments, the memory device 250 includes data storage 252 for storing data related to the financial institution including but not limited to data created and/or used by the matching application 258, and/or the loyalty database 260.

In the embodiment illustrated in FIG. 2 and described throughout much of this specification, the matching application 258 allows for user 202 enrollment, collection of data, matching of data, matching of user 202 identification, confirmation of user's identification, and delivery of loyalty and/or coupons to a merchant system 206 and/or other merchants systems 210.

In some embodiments, the matching application 258 allows for user 202 to enroll into the loyalty identification matching program. A user 202 may enroll in several ways, including, but not limited to manual enrollment, automatic enrollment, secondary enrollment, and/or the like. In some embodiments, the matching application 258 may allow a user 202 to enroll into the loyalty identification matching program by inputting his/her information into an enrollment form. The enrollment form may be accessed through the user's online banking, mobile banking, the Internet, at a merchant, at a financial institution, and/or the like. The user 202 may complete the enrollment form using his/her user device 204, hand writing etc. In other embodiments, the user 202 may automatically be enrolled in the loyalty identification matching program. In this way, the matching application 258 may recognize that the user 202 is an account holder at the financial institution, is a loyalty account holder with a merchant, is involved in a coupon program, and/or another merchant or financial institution program. In this way, the matching application 258 may determine information required to enroll the user 202 in the loyalty identification matching program based on enrollment information the user 202 may have previously enrolled. In some embodiments, whether manually or automatically, the user 202 may select to opt-in to enroll in the loyalty identification matching program prior to the matching application 258 enrolling the user 202 and populating the user's loyalty database 260 with the user's enrollment data.

Whether manually or automatically, the matching application 258 may receive enrollment data from the user 202 and/or acquire the enrollment data from other sources. The other sources may include the user's financial institution, prior enrollment with merchants or other entities. The enrollment data may include, but is not limited to, the user's name, address, telephone number, loyalty account information, family member information, and/or the like.

In some embodiments, the matching application 258 matches information collected from the user 202 with loyalty accounts the user 202 may have. The matching application 258, using the enrollment data, may communicate with the merchant system 206 and other merchant systems 210 to determine all loyalty accounts the user 202 may have with various merchants, entities, businesses, other individuals, etc. In this way, the matching application 258 may determine all of the loyalty accounts that the user 202 may be associated with, without the user 202 having to provide all of the user's loyalty accounts and the numbers and/or bar codes associated therewith. The matching application 258 may determine, from the enrollment data each of the one or more loyalty accounts that a user 202 may be enrolled in.

Furthermore, the matching application 258, again using the user 202 information from enrollment may also be able to determine other programs, such as coupon programs, discount programs, rewards programs, etc. that the user 202 may also be enrolled in.

Once the matching application 258 determines the user 202 information, collects all the loyalty accounts associated with the user 202, and determines other programs the user 202 is associated with, the matching application 258 may populate the user's loyalty database 260 with all of this information. As such, the matching application 258 may the various data to the user 202, such that the user's enrollment data may be associated with his/her loyalty accounts, and other programs in the loyalty database 260. For example, if the matching application 258 determines that a user 202 has a loyalty card with Merchant A, Merchant B, and Merchant D, the matching application 258 may determine that the user 202 has these loyalty cards by communicating with the systems associated with Merchant A, Merchant B, and Merchant D. The matching application 258 may then associate the loyalty accounts found for the user 202 with the user 202 loyalty database 260 associated with the user's enrollment data and other programs associated with the user 202.

Once the user's enrollment data and loyalty accounts are stored in the user loyalty database 260, the matching application 258 may associate any coupons that the user 202 may have access to with the user 202 information and loyalty accounts stored in the user's loyalty database 260. The matching application 258 may determine the coupons available for the user 202 in several ways, including but not limited to, automatically adding coupons, allowing the user 202 to manually add coupons, merchant added coupons, etc. Once the coupons are added to the user loyalty database 260, the user 202 may be able to make a transaction using a loyalty account and the coupons stored in association with that loyalty account may also be used for that transaction. In this way, the user 202 may not have to bring the coupons to the store, but instead may present the user's loyalty account to the merchant to be able to utilize the coupons. In some embodiments, the user 202 may be able to add coupons to his/her loyalty database 260 via his/her user device 204, the Internet, mobile application, etc. In some embodiments, the merchant application 258 may automatically provide the user's loyalty database 260 with coupons. For example, if the user 202 is associated with a coupon program or the like, the coupons from the coupon program may be automatically provided to the user's loyalty database 260. In other embodiments, coupons may be added to the user's loyalty database 260 by a merchant. In this way, the merchant may provide the matching application 258 with the coupons it has to offer users 202 and store them with the user's enrollment data and loyalty accounts in the loyalty database 260. In this way, when a user 202 uses his/her loyalty account, coupons that are stored with the loyalty account for that user 202 may be used for that transaction.

Once the matching application 258 has populated a user's loyalty database 260 with the user's enrollment data, loyalty accounts, and coupons, the matching application 258 may receive communications from a merchant system 206 that a user 202 may be transacting with. The user 202 may provide the merchant with identification, such as a user 202 identifier. This identification may be substituted for the user 202 presenting a loyalty card, keychain card, paper coupon, etc. to the merchant. Instead, the user 202 may provide a user 202 identifier, such as, but not limited to the user's phone number, PIN number, code, password, etc. to the merchant. The merchant may then communicate the user 202 identifier to the matching application 258. The matching application 258 may match the user 202 identifier with the user's enrollment data provided to the matching application 258 when the user 202 enrolled in the program. If there is a match between the user 202 identifier and the user's enrollment data stored in the loyalty database 260, the matching application 258 may confirm that the user 202 identifier is associated with the specific user 202 initiating a transaction with a merchant.

Once a merchant system 206 sends the user 202 identifier to the matching application 258 and the user 202 identifier is confirmed, the matching application 258 may search the user's loyalty database 260 to determine the loyalty accounts and/or coupons that the user 202 may be able to utilize for a transaction with the merchant. For example, if the matching application 258 receives a user 202 identifier from a merchant system 206 associated with Merchant A, the matching application 258 will search the user's database 260 for any loyalty accounts and/or coupons that Merchant A will accept. Furthermore, the matching application 258 may also search for all coupons associated with products the user 202 is purchasing during the transaction. These coupons may be coupons that the user 202 has provided to his/her loyalty database 260, merchant provided coupons, other merchant provided coupons, manufacturer provided coupons, and/or the like. In this way, the matching application 258 may determine all coupons for the products the user 202 is currently purchasing. For example, if the merchant accepts coupons from other merchants for specific products the matching application 258 may determine, in real-time, the products the user 202 is purchasing and whether there are coupons available for that product. Therefore, when the user completes the transaction, all coupons that the user 202 may be able to use for the products he/she is purchasing may be utilized.

The matching application 258 may then communicate the user's loyalty account and coupons back to the merchant system, such that the user's current transaction with the merchant may incorporate his/her loyalty account and coupons into the transaction. In this way, the user 202 does not have to provide the merchant with his/her loyalty card or coupons, but instead, may just provide the merchant with his/her user 202 identifier, such as a phone number, during the transaction. The merchant system 206 may then communicate with the matching application 258 via a network 201. This communication allows the matching application 258 to provide the merchant system 206 with all loyalty accounts and coupons associated with the merchant and/or the products the user 202 is currently transacting. In this way, the user 202 may present his/her phone number at a point-of-transaction such that the merchant system 206 may communicate the phone number to the matching application 258. The matching application 258 may then associated the user's phone number with the loyalty accounts and coupons on the loyalty database 260. The matching application 258 may then communicate the loyalty accounts and coupons back to the merchant system 206 to be incorporated into the transaction the user 202 is entering into. This way, the loyalty accounts and/or coupons may be accounted for and utilized in association with the transaction the user 202 is currently entering with a merchant.

Furthermore, if the matching application 258 receives a user 202 identifier from a merchant that, after searching the loyalty database 260, it is determined that the user 202 matching that user 202 identifier does not have any loyalty accounts and/or coupons that correspond to that merchant the matching application 258 may offer the user 202 to enroll in that merchant's loyalty account. In some embodiments, the user 202 may be offered enrollment via his/her user device 204. In other embodiments, the user 202 may be automatically enrolled. In this way, the matching application 258 may be able to automatically enroll the user 202 in a loyalty account associated with that merchant by utilizing the user's enrollment data that the matching application 258 received when the user 202 enrolled in the loyalty identification matching program. Utilizing this information, the matching application 258 may provide the merchant system 206 the necessary information, such as the user's name, phone number, etc. that may be required by the merchant to enroll in their loyalty program. The user 202 may then be able to receive a loyalty account with that merchant and be able to utilize that loyalty account during his/her current purchase.

As further illustrated in FIG. 2, the financial institution server 208 further comprises a loyalty database 260. The loyalty database 260 may store any user 202 information, loyalty accounts, and/or coupons. The loyalty database 260 stores this information stores all of the data collected for a user 202 together. This way, the loyalty database 260 knows the user's identifier and may quickly access all data associated with that user 202 based on the identifier.

In some embodiments, the loyalty database 260 stores user 202 information, such as enrollment data. The enrollment data stored in the loyalty database 260 may include, but is not limited to, the user's name, address, telephone number, loyalty account information, family member information, and/or the like. The loyalty database 260 may also store the user 202 identifier associated with the user 202. The user 202 identifier may be the user's telephone number, a PIN number, code, password, etc. The user 202 identifier may be one of the ways the loyalty database 260 for a user 202 is searched for and found. For example, when the matching application 258 receives a user 202 identifier from a merchant system 206, the matching application 258 searches the loyalty database 260 to find the user 202 associated with that user 202 identifier. The user 202 identifier provided by the merchant system 206 may have been received at the merchant system 206 by a user 202 transacting with that merchant.

In some embodiments, the loyalty database 260 stores loyalty accounts associated with the user 202. Based on the user 202 information received during enrollment the matching application 258 may communicate with merchants providing a loyalty account program. The matching application 258 may determine all of the loyalty accounts the user 202 has previously enrolled in for all merchants providing a loyalty account program. These loyalty accounts may then be stored associated with the user 202 in the loyalty database 260. The loyalty accounts may include bar codes, account numbers, QR codes, and/or the like that a merchant may use to identify the loyalty account during a transaction.

In some embodiments, the loyalty database 260 stores coupons associated with the user 202. Coupons may be added to the loyalty database 260 in several ways, including but not limited to, automatically adding coupons, allowing the user 202 to manually add coupons, allowing merchants added coupons, etc. In some embodiments, the user 202 may be able to add coupons to his/her loyalty database 260 via his/her user device 204, the Internet, mobile application, etc. In some embodiments, the merchant application 258 may automatically provide the user's loyalty database 260 with coupons. For example, if the user 202 is associated with a coupon program or the like, the coupons from the coupon program may be automatically provided to the user's loyalty database 260. In other embodiments, coupons may be added to the user's loyalty database 260 by a merchant. In this way, the merchant may provide the loyalty database 260 with the coupons it has to offer users 202. The coupons that correspond to loyalty accounts held by the user 202 are then stored with the user's data in the loyalty database 260. Furthermore, coupons that are available for products that the user 202 may purchase are stored and communicated to the matching application 258 when the user 202 is entering into a transaction for that product. In this way, the user 202 may be able to utilize coupons from manufacturers, other merchants (price matching), etc. in real-time during the user's transaction with the merchant.

Finally, the loyalty database 260 stores the user's loyalty accounts and coupons together with the user's enrollment data. In this way, when the matching application 258 receives a user 202 identifier from a merchant system 206, the loyalty database 260 may be able to quickly search and find the loyalty accounts and coupons available for the user 202 to utilize during that transaction. Furthermore, the loyalty database 260 also stores coupons associated with other merchants, vendors, advertisers, manufacturers, and the like. In this way, the loyalty database 260 may determine from merchant system 206 communications, products that the user 202 is transacting for during the current transaction. The loyalty database 260 may, in turn, then be able to be searched to find and provide coupons for the products that the user 202 is transacting for that the merchant may also accept. For example, the user 202 may be purchasing Product A, Product B, and Product C from Merchant A. The loyalty database 260 may determine the user 202 is purchasing Product A and find a coupon for Product A provided by the manufacturer of Product A. If it is determined that Merchant A accepts coupons from the manufacturer of Product A, the loyalty database 260 may provide this coupon along with the user's loyalty account for Merchant A, and other coupons for Merchant A for use during the transaction.

FIG. 2 also illustrates a user device 204. The user device 204 generally includes a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the financial institution server 208, the merchant system 206, and the other merchants systems 210. As such, the communication device 212 generally includes a modem, server, or other device for communicating with other devices on the network 201.

As further illustrated in FIG. 2, the user device 204 include a computer-readable instructions 220 stored in the memory device 216, which in one embodiment includes the computer-readable instructions 220 of a user application 222. In this way, a user 202 may be able to enroll in the loyalty identification matching program, add loyalty accounts, provide user 202 identifiers, and/or the like using the user application 222. In some embodiments, the memory device 216 includes data storage 218 for storing data related to the user device 204 including but not limited to data created and/or used by the user application 222. A “user device” 204 may be any communication device, such as a cellular telecommunications device (e.g., a cell phone or mobile phone), personal digital assistant (PDA), a mobile Internet accessing device, Internet accessing device, or other device including, but not limited to PDAs, pagers, televisions, gaming devices, laptop computers, desktop computer, cameras, video recorders, audio/video player, radio, Global Positioning System (GPS) devices, any combination of the aforementioned, or the like. Although only a single user device 204 is depicted in FIG. 2, the loyalty identification matching system environment 200 may include numerous user devices 204.

In some embodiments, the user device 204 allows a user 202 to enroll in the loyalty identification matching program. The enrollment may be done via an interface, the Internet, text message, voice messages, and/or the like. In this way, the user 202 may be able to provide enrollment information to the financial institution server 208 such that the user 202 may be enrolled into the loyalty identification matching program to receive loyalty account and coupons at a merchant point-of-transaction by providing a user 202 identifier to the merchant.

In some embodiments, the user 202 may use the user device 204 to add loyalty accounts. In this way, the user 202 may manually add loyalty accounts to his/her loyalty identification matching program. The user 202 may input numbers associated with the user's loyalty account, such as the account numbers. The user 202 may also scan a bar code, QR code or the like with his/her mobile device 204 to add a loyalty account associated with the bar code.

Finally, in some embodiments, the user 202 may provide the merchant and/or the merchant system 206 with the user 202 identifier to the merchant system 206. In this way, the user 202 may use text communication, voice communication, etc. the user 202 identifier to the merchant system 206 without the user 202 having to voice the user 202 identifier to the merchant. This may ensure privacy to the user 202 so that he/she may not have to provide the user 202 identifier to the merchant in a public place. In this way, the user 202 may text the user 202 identifier to the merchant system 206 via the network 201 such that the merchant system 206 may receive the user 202 identifier and subsequently communicate it to the matching application 258.

The merchant system 206 generally comprises a reader device 235, a communication device 236, a processing device 238, and a memory device 240. The processing device 238 is operatively coupled to the communication device 236 and the memory device 240. The processing device 238 uses the communication device 236 to communicate with the network 201 and other devices on the network 201, such as, but not limited to the financial institution server 208, the user device 204, and the other merchants systems 210. As such, the communication device 236 generally comprises a modem, server, or other device for communicating with other devices on the network 201. Furthermore, the reader device 235 allows a merchant system 206 to determine if a user 202 is in communication with the merchant. In some embodiments, the reader device 235 may be a point-of-transaction device, a point-of-sale device, or a like device able to receive and/or process the purchase of a product at the merchant. A reader device 235 may also comprise a type of location device, such that a merchant may be able to detect a user 202 within the merchant's place of business.

As further illustrated in FIG. 2, the merchant system 206 comprises computer-readable instructions 242 stored in the memory device 240, which in one embodiment includes the computer-readable instructions 242 of a merchant application 244. In this way, in some embodiments, a merchant may be able to send user 202 identifiers, communicate with, and receive loyalty identification matching data, such as accounts and coupons from the matching application 258 of the financial institution server 208. In some embodiments, the memory device 240 includes data storage for storing data related to the merchant system 206 including but not limited to data created and/or used by the merchant application 244.

Furthermore, the merchant application 244 allows the merchant to send user 202 identifiers to the financial institution server 208, communicate with the other devices on the network 201, and receive loyalty identification matching data from the financial institution serve 208.

In some embodiments, the merchant systems 206 may send user 202 identifiers received from a user 202 to the financial institution server 208 for confirmation and loyalty account information. Next, in some embodiments, the merchant application 244 may receive loyalty identification matching data from the financial institution server 208, such that the user's loyalty account associated with that merchant may be applied to the transaction the user 202 is entering. Along with the loyalty account the user 202 has associated with the merchant, the matching application 258 may also provide coupons the user 202 has access to that are also accepted by the merchant. Furthermore, the loyalty identification matching data may also communicate with the other devices on the network 201 to provide the user 202 identifier, the products of the transaction, and other transaction information to the other systems on the network 201.

The other merchants systems 210 are operatively coupled to the financial institution server 208, the user device 204, and the merchant system 206 through the network 201. In this way, the other merchants systems 210 have systems with devices the same or similar to the devices described for the financial institution server 208, the user device 204, and the merchant system 206 (e.g., a communication device, a processing device, and a memory device). Therefore, the other merchants systems 210 communicate with the financial institution server 208, the user device 204, and/or the merchant system 206 in the same or similar way as previously described with respect to each system. The other merchants systems 210, in some embodiments, is comprised of systems and devices that allow the financial institution server 208 to access merchants information relating to loyalty accounts and coupons available through the merchants associated with the other merchants systems 210.

It is understood that the servers, systems, and devices described herein illustrate one embodiment of the invention. It is further understood that one or more of the servers, systems, and devices can be combined in other embodiments and still function in the same or similar way as the embodiments described herein.

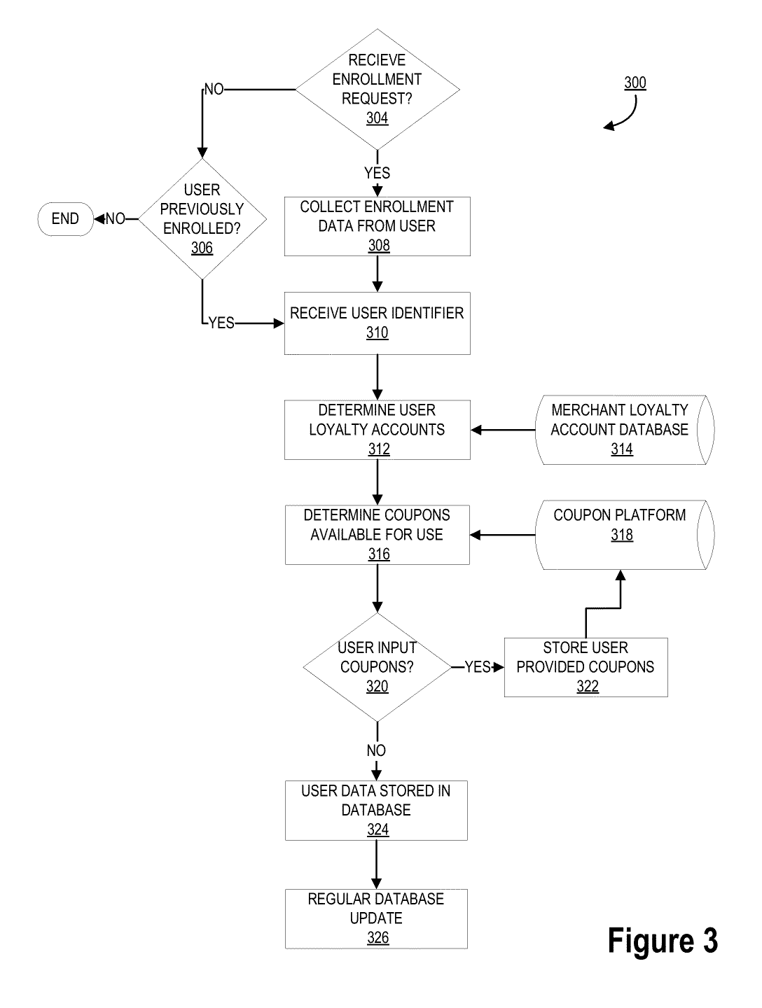

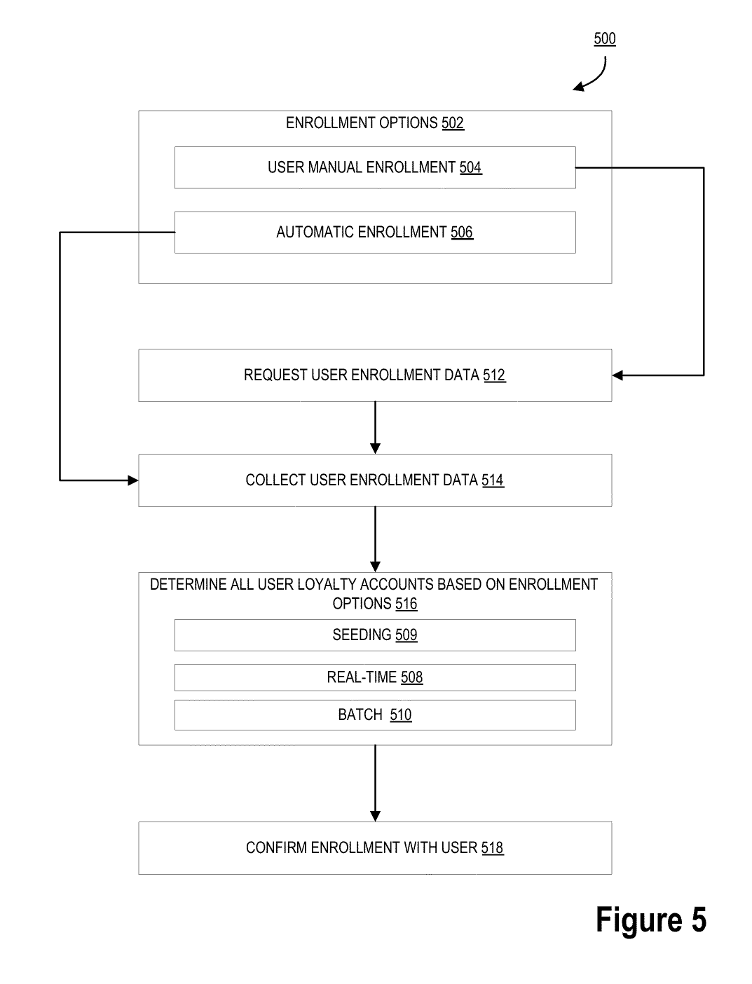

FIG. 3 illustrates a flow chart of the process of population of the loyalty identification matching program system 300, in accordance with one embodiment of the present invention. The flow chart illustrates one embodiment of the flow of data throughout the system. As illustrated in decision block 304, the system determines if an enrollment request has been received. The enrollment request may be received from a user 202, through various means, including, but not limited to, an interface, paper, Internet, via the user device 204, at a financial institution, at a merchant, and/or the like. Furthermore a user 202 may enroll in several ways, including, but not limited to manual enrollment, automatic enrollment, secondary enrollment based on enrollment in other programs, and/or the like, such as illustrated in FIG. 5.

If the system determines that an enrollment request was received in decision block 304 then the system will collect enrollment data from the user 202, as illustrated in block 308. Referring back to decision block 304, if no enrollment request has been received the system may, as illustrated in decision block 306, determine if the user 202 has previously enrolled in the loyalty identification matching program and/or has been automatically enrolled based on other programs the user 202 is enrolled in. In some embodiments, the user 202 may have previously enrolled in the loyalty identification matching program, as such the system has the user's enrollment data and does not have to collect the data again. In other embodiments, the user 202 may automatically be enrolled in the loyalty identification matching program. Automatic enrollment may be based on other programs the user 202 is enrolled in. In this way, the user 202 may be automatically enrolled in the loyalty identification matching program in conjunction with other programs, such as, but not limited to loyalty programs, rewards programs, coupon programs, merchant provided programs, financial institution provided programs, etc.

If it is determined that the user 202 has not previously enrolled in the loyalty identification matching program or in another program the process may end there. However, if a previous enrollment is discovered in decision block 306 the system then may receive a user 202 identifier, as illustrated in block 310. The user 202 identifier may be selected by the user 202 to provide to a merchant for the loyalty identification matching program. The user 202 identifier may include, but is not limited to, the user's phone number, PIN number, password, passcode, etc. In this way, the system may recognize the user 202 identifier based on the user's enrollment data. The system may be provided the user 202 identifier from a merchant that the user 202 is currently wishing to transact with. In this way, when the user 202 approaches the merchant's point-of-transaction, the user 202 may provide the merchant with his/her user 202 identifier. The merchant may then provide the user 202 identifier to the system, as illustrated in block 310.

Once the user 202 identifier has been received in block 310, the system may determine all the loyalty accounts the user has, as illustrated in block 312. The loyalty accounts of a user 202 may be determined using several means, including, but not limited to, searching previously stored user loyalty accounts, communicating with merchants to determine if the user 202 has loyalty accounts with that merchant, and/or receiving loyalty accounts from the user 202. In some embodiments, previously discovered loyalty accounts may be stored in a merchant loyalty account database 314. The merchant loyalty account database 314 stores loyalty accounts for users 202 that the system has received from the user 202 or from merchants. The loyalty accounts in the merchant loyalty account database 314 are stored with the user's enrollment data such that the loyalty accounts may be associated with the user 202 and the user's identifier.

Next, as illustrated in block 316, coupons that the user 202 has available for use for a transaction are determined. Coupons available to the user 202 may include, but are not limited to, coupons the user 202 inputted into the loyalty identification matching program, merchant coupons, coupons from various coupon programs, rewards coupons, etc. Coupons available to the user 202 may be stored in a coupons platform 318. The coupon platform 318 stores coupons associated with the user's loyalty accounts. In this way, the coupons match to the various loyalty accounts the user 202 has. For example, if the user 202 has loyalty accounts for Merchant A and Merchant B but not for Merchant C, the coupons available to the user 202 that are stored in the coupon platform 318 are only those coupons that are accepted at Merchant A and Merchant B, not coupons only accepted at Merchant C. In this way, when the user 202 enters into a transaction, the system may determine the merchant, provide the user's loyalty account information to that merchant, and also provide any coupons the user 202 may have available to use for a transaction with that merchant.

The coupons stored in the coupon platform 318 include any offers, promotions, coupons, sales, rewards points, special offers, etc. that the user 202 may have for that merchant. These coupons may be received from the merchant, a manufacturer of products, advertisers, the user 202, etc. In this way, the coupons available for the user may also include product specific or transaction specific coupons. Therefore, the system may continually monitor the user's transaction and determine if there are coupons available for the products of the transaction. For example, a user 202 may have provided Merchant A with his/her user 202 identifier. The user 202 may then be in the process of a transaction with Merchant A. During the transaction the system monitors the products being purchase and determines if the user 202 has coupons available for those products. For example, if the user 202 is purchasing Product A, Product B, and Product C, the system may determine that the manufacturer of Product B has a coupon that is accepted by Merchant A. The system then provides Merchant A with that coupon along with the user's loyalty account prior to the transaction being complete, such that the coupon for Product B and the user's loyalty account may be applied to the transaction.

In some embodiments, the user 202 may input coupons into the loyalty identification matching program, as illustrated in decision block 320. If the user 202 does decide to input coupons in decision block 320 the user 202 inputted coupons are then stored in the coupon platform 318 with the other coupons available for the user 202. In some embodiments, the user 202 may input coupons prior to a transaction with a merchant. In some embodiments, the user 202 may input coupons during the transaction with a merchant. If the user 202 does not decide to input coupons, the process continues.

Next, as illustrated in block 324 all of the user 202 data is stored together in a database. In this way, the user 202 enrollment data, the user 202 loyalty accounts, and the coupons available to the user 202 are all stored in association with the user's identifier. In this way, when a merchant sends a user identifier to the system, the system may quickly search and find all loyalty accounts and coupons the user 202 may have and provide them to the merchant. Finally, as illustrated in block 326, the system regularly updates the user database. In this way, loyalty accounts that the user 202 recently signed up for, recent merchant coupons, etc. may be available to the whenever the user 202 is entering into a transaction.

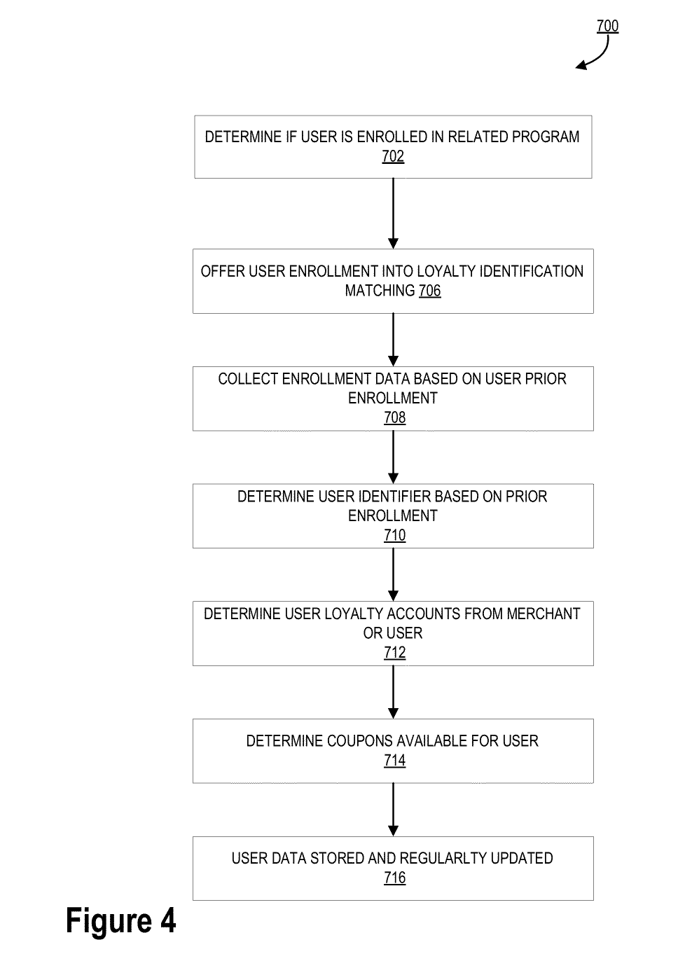

FIG. 4 illustrates a process map of populating of the loyalty identification matching program system 700, in accordance with one embodiment of the present invention. First, the system may determine if the user 202 has enrolled in programs other than the loyalty identification matching program, such as a financial institution program or merchant program. As illustrated in block 702 the system may determine if the user 202 is enrolled in related programs 702. A related program may include any program, such as accounts, savings programs, budgeting programs, etc. that a financial institution providing the loyalty identification matching program. Furthermore, a related program may include a merchant program, such as rewards accounts, merchant coupon programs, and/or the like.

After the system determines whether the user 202 has previously enrolled in a related program in block 702, the system may then offer the user 202 enrollment into the loyalty identification matching program, as illustrated in block 706. In some embodiments, the system may automatically enroll the user 202 in the loyalty identification matching program when it is determined that the user 202 has previously enrolled in a financial institution program and/or a merchant program. In other embodiments, the system may, as illustrated in block 706 offer the user 202 enrollment in to the loyalty identification matching program. In some embodiments, the user 202 may be offered enrollment into the loyalty identification matching program without the user 202 being enrolled in a prior program.

If the user 202 selects enrollment from the enrollment offer illustrated in block 706, the system may then collect user 202 enrollment data based on the user's prior enrollment in a financial institution program, and/or a merchant program, as illustrated in block 708. Although a user 202 may be able to provide enrollment without previously enrolling in a program, this embodiment utilizes the data from previous enrollment in programs to determine the required enrollment information for the loyalty identification matching program. Next, based on the prior program enrollment the system may determine the user 202 identifier, as illustrated in block 710. In this way, the system may determine a phone number, PIN number, password, etc. that a user 202 may use for the loyalty identification matching program. Next, once the user 202 has enrolled, the system may determine loyalty accounts from a merchant and/or user inputs, as illustrated in 712. Next, once the loyalty accounts are determined, the system determines coupons available for the user 202, as illustrated in block 714. The coupons may be determined based on the loyalty accounts the user 202 has enrolled in, merchant provided coupons, previously enrolled in coupon and/or rewards programs, etc. Finally, as illustrated in block 716, the user data is stored and regularly updated. In this way, the enrollment data from the user's previous program enrollment, the user's loyalty accounts determined, and the coupons available for the user 202 are all stored together, such that the system may easily access the user's loyalty accounts and coupons based on the user's identifier.

FIG. 5 illustrates a process map for user 202 enrollment options for the loyalty identification matching program 500, in accordance with an embodiment of the invention. The enrollment options 502 include, but are not limited to user manual enrollment 504 and automatic enrollment. Manual enrollment 504 allows a user 202 to enroll into the loyalty identification matching program by inputting his/her enrollment data into an enrollment form. The enrollment form may be accessed through the user's online banking, mobile banking, the Internet, at a merchant, at a financial institution, and/or the like. The user 202 may complete the enrollment form using his/her user device 204, hand writing etc. Automatic enrollment 506 allows the system to automatically enroll the user 202 in the loyalty identification matching program. In this way, the system may recognize other programs the user 202 is currently enrolled in and using that information automatically enroll the user 202 into the loyalty identification matching program. The other programs may include, but are not limited to, merchant programs, financial institution programs, advertiser programs, and/or other programs the entity providing the loyalty identification matching program may offer.

If it is determined that the user 202 is enrolling via user manual enrollment 504 the system may request enrollment data from the user 202, as illustrated in block 512. Enrollment data may include, but is not limited to the user's name, address, phone number, loyalty account information, email address, user identifier, etc. Next, as illustrated in block 514 to system may collect user enrollment data. If the user enrolled via user manual enrollment 504 the system may receive the user enrollment data and user identifier from the user 202. If it is determined that the user 202 automatically the enrollment data collected in block 514 may be collected directly from the other program provider. In this way, the user 202 may not have to fill out any enrollment form or the like, the system may receive the user's prior enrollment information from many sources, including but not limited to merchants, entities, or financial institutions having the user's information, entities running the other programs that the user 202 is enrolled in, etc. This reduces the friction of requiring the user 202 to take time to provide enrollment data via user 202 input, instead allowing the user's enrollment data to be sent directly to the system, such that the user 202 may be automatically enrolled in the loyalty identification matching program.

Next, as illustrated in block 516 the system determines the loyalty accounts that are available to the user 202, based on the enrollment data provided via an enrollment option. The system may determine the loyalty accounts by seeding 509, in real-time 508, and/or by batch 510 determination. Furthermore, the system may determine loyalty accounts based on user enrollment data that may have included loyalty account information. Seeding 509 allows the system to reach out to merchants providing loyalty accounts and determine loyalty accounts users 202 have with the merchants by providing the user's name to the merchant. In this way, the system may not have to directly communicate with the merchant, but instead may be able to be sent information about each user 202 enrolled in the loyalty identification matching program from each merchant when it is determined that the user 202 is enrolled in a merchant's loyalty account program. In some embodiments the loyalty accounts associated with the user 202 may be determined in real-time 508. In this way, upon enrollment or upon transacting with a merchant the system may determine, prior to the completion of the transaction, that the user 202 is a loyalty account holder with that merchant. The system may communicate with the merchant during the transaction to determine if the user 202 is a loyalty account holder at that merchant. If the user 202 is a loyalty account holder, then the system will determine that he/she is based on communicating with the merchant. Finally, the system may determine the user's loyalty account by batch 510. In this way, the system may search each merchant's loyalty account data to determine if the user 202 of the loyalty identification matching program matches any of the merchant's loyalty accounts. An individual merchant loyalty account system may be search weekly, monthly, etc. to determine if a user 202 of the loyalty identification matching program is a loyalty account holder for that merchant. In this way, the system does not disclose any information about the user 202 to the merchant, but instead only searches merchant loyalty account holder databases to determine if users 202 are loyalty account holders for that particular merchant. Finally, as illustrated in block 518, the user's enrollment in the loyalty identification matching program is confirmed.

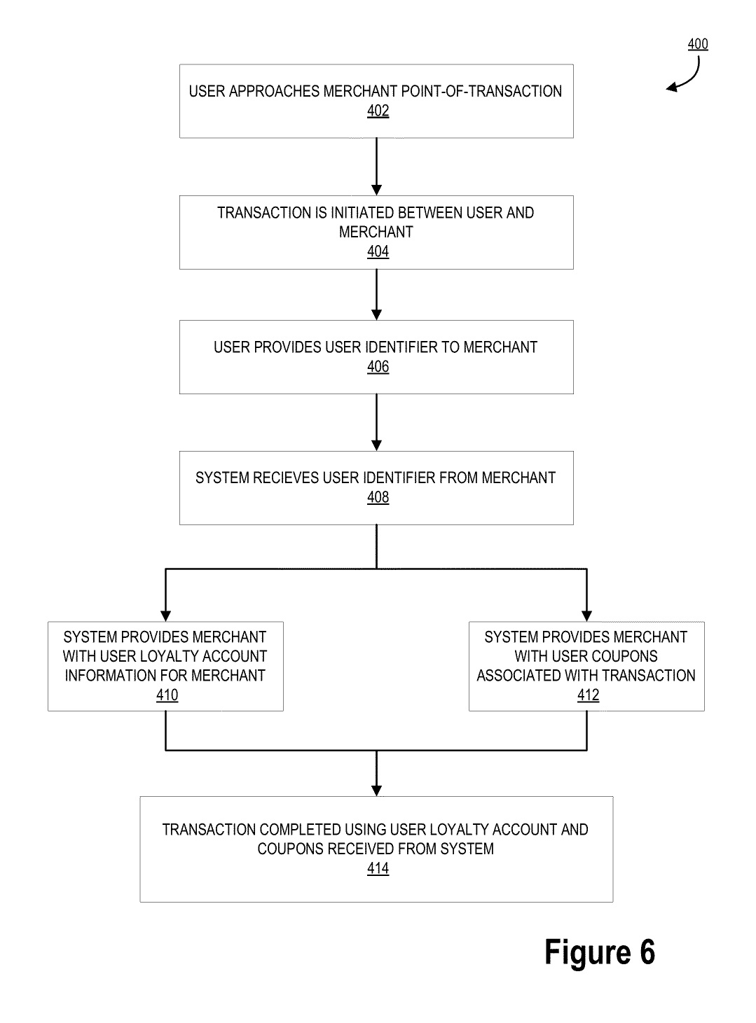

FIG. 6 illustrates a process map of the loyalty identification matching program being used for a merchant transaction 400, in accordance with one embodiment of the present invention. First, the user 202 may approach a merchant's point-of-transaction, as illustrated in block 402. In this way, the user 202 may be wishing to transact with the merchant to purchase products with that merchant. Once the user 202 approaches the merchant's point-of-transaction, as illustrated in block 402, a transaction may be initiated between the user and the merchant, as illustrated in block 404. In this way, the user 202 may be purchasing products, such as goods, services, etc. with the merchant. This transaction may be at a physical location, a virtual store, via the Internet, and/or the like.

After the user 202 has initiated a transaction with the merchant, as illustrated in block 404 the user may provide the merchant with the user 202 identifier, as illustrated in block 406. In this way, the user 202 may speak, text, etc. the user 202 identifier to the merchant. The merchant, via the merchant system 206 may communicate the user identifier to the system. The system may then, as illustrated in block 408 receive the user identifier from the merchant.

Once the system receives the user identifier from the merchant, the system may determine the loyalty account information, in block 410 and/or the user coupons, in block 412. As illustrated in block 410 the system may provide the merchant with user loyalty account information associated with that merchant. In this way, the system may provide the merchant with the user's loyalty account information, such that the user 202 may not have to provide his/her loyalty account to the merchant. For example, instead of the user 202 providing a keychain card or the like, the user 202 may provide the merchant with the user 202 identifier. The system will then provide the merchant with the user's loyalty account information based on the user 202 identifier. Next, as illustrated in block 412, the system may also provide the merchant with coupons associated with the transaction. The coupons may be provided by the user 202, the merchant, a manufacturer of products, other merchants, and/or the like. The coupons provided by the system may be merchant and/or product specific. In this way, the system may determine the products the user 202 is transaction for and subsequently determine and provide the merchant with all coupons available for the user 202 for those products. In this way, the user 202 may only have to provide a user 202 identifier in order to utilize coupons for the transaction. Therefore, the user 202 may not have to provide the merchant with cut-out, printed off, codes, etc. coupons for the transaction, but instead provide his/her user 202 identifier, such that the system may communicate all available coupons to the merchant for the user's transaction.

Finally, as illustrated in block 414, the transaction may be completed using the user 202 loyalty account and/or the coupons received from the system. The loyalty account and the coupons may be provided to the merchant in the same communication or in different communications. Furthermore, the loyalty account and/or coupons may be provided at the beginning of the transaction, end of the transaction, and/or any time during the transaction. The loyalty account and/or coupons will be applied to the user's transaction, such that the final price of the transaction may reflect the loyalty account and/or coupons used.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that all computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the all computer-executable program code portions for carrying out operations of embodiments of the present invention are written in conventional procedural programming languages, such as the “C” programming languages and/or similar programming languages. The computer program code may alternatively or additionally be written in all multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by all computer-executable program code portions. These all computer-executable program code portions may be provided to a processor of a general purpose computer, special purpose computer, and/or some other programmable data processing apparatus in order to produce a particular machine, such that the all computer-executable program code portions, which execute via the processor of the computer and/or other programmable data processing apparatus, create mechanisms for implementing the steps and/or functions represented by the flowchart(s) and/or block diagram block(s).

It will also be understood that the all computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The all computer-executable program code portions may also be loaded onto a computer and/or other programmable data processing apparatus to cause a series of operational steps to be performed on the computer and/or other programmable apparatus. In some embodiments, this produces a computer-implemented process such that the all computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for providing loyalty account information, the system comprising:
a memory device with computer-readable program code stored thereon;
a communication device;
a processing device operatively coupled to the memory device and the communication device, wherein the processing device is configured to execute the computer-readable program code to:
receive an enrollment indication for a user, wherein the enrollment indication comprises a user identifier;
determine loyalty accounts associated with the user, wherein the loyalty accounts are determined by communicating with merchants providing the loyalty accounts, wherein the loyalty accounts are then stored in association with the user identifier;
receive a communication from a merchant comprising the user identifier, wherein the communication is part of transaction with the merchant;
match the user identifier communicated from the merchant with the loyalty accounts associated with the user identifier;
determine if the loyalty accounts associated with the user identifier received from the merchant are accepted by the merchant; and
provide the merchant with the loyalty accounts accepted by the merchant, such that the loyalty accounts can be applied to the transaction with the merchant.

2. The system of claim 1, wherein the processing device is further configured to execute the computer-readable program code to:
determine coupons available to the user;
store the coupons in association with the user identifier and the loyalty accounts;
determine coupons that the merchant of the transaction accepts; and
provide the merchant with the coupons acceptable by the merchant in association with the loyalty accounts accepted by the merchant, such that the coupons and loyalty accounts can be applied to the transaction with the merchant.

3. The system of claim 1, wherein the enrollment indication is automatically provided based at least in part on the user previously enrolling in another program, wherein the another program is provided by one or more of the merchant or a financial institution.

4. The system of claim 1, wherein the user identifier is a unique identifier of a user, wherein the user identifier is a telephone number associated with the user.

5. The system of claim 1, wherein determining loyalty accounts associated with the user further comprises receiving loyalty account information from one or more of the user or the merchant.

6. The system of claim 2, wherein determining coupons available to the user further comprises receiving coupons from one or more of the merchant offering the coupons or the user.

7. The system of claim 1, wherein the transaction is at a physical point-of-transaction of the merchant.

8. The system of claim 1, further comprising providing automatic enrollment in one or more loyalty accounts associated with the merchant if no loyalty accounts associated with the user identifier received from the merchant are accepted by the merchant.

9. A computer program product for providing loyalty account information, the computer program product comprising at least one non-transitory computer-readable medium having computer-readable program code portions embodied therein, the computer-readable program code portions comprising:
an executable portion configured for receiving an enrollment indication for a user, wherein the enrollment indication comprises a user identifier;
an executable portion configured for determining loyalty accounts associated with the user, wherein the loyalty accounts are determined by communicating with merchants providing the loyalty accounts, wherein the loyalty accounts are stored in association with the user identifier;
an executable portion configured for receiving a communication from a merchant comprising the user identifier, wherein the communication is part of transaction with the merchant;
an executable portion configured for matching the user identifier communicated from the merchant with the loyalty accounts associated with the user identifier;
an executable portion configured for determining if the loyalty accounts associated with the user identifier received from the merchant are accepted by the merchant; and
an executable portion configured for providing the merchant with the loyalty accounts accepted by the merchant, such that the loyalty accounts can be applied to the transaction with the merchant.

10. The computer program product of claim 8, wherein the computer-readable program code portions further comprise:
an executable portion configured for determining coupons available to the user;
an executable portion configured for storing the coupons in association with the user identifier and the loyalty accounts;
an executable portion configured for determining coupons that the merchant of the transaction accepts; and
an executable portion configured for providing the merchant with the coupons acceptable by the merchant in association with the loyalty accounts accepted by the merchant, such that the coupons and loyalty accounts can be applied to the transaction with the merchant.

11. The computer program product of claim 8, The system of claim 1, wherein the enrollment indication is automatically provided based at least in part on the user previously enrolling in another program, wherein the another program is provided by one or more of the merchant or a financial institution.

12. The computer program product of claim 8, wherein the user identifier is a unique identifier of a user, wherein the user identifier is a telephone number associated with the user.

13. The computer program product of claim 8, wherein determining loyalty accounts associated with the user further comprises receiving loyalty account information from one or more of the user or the merchant.

14. The computer program product of claim 9, wherein determining coupons available to the user further comprises receiving coupons from one or more of the merchant offering the coupons or the user.

15. The computer program product of claim 8, wherein the transaction is at a physical point-of-transaction of the merchant.

16. The computer program product of claim 8, further comprising providing automatic enrollment in one or more loyalty accounts associated with the merchant if no loyalty accounts associated with the user identifier received from the merchant are accepted by the merchant.

17. A method for providing loyalty account information, the method comprising:
receiving an enrollment indication for a user, wherein the enrollment indication comprises a user identifier;
determining loyalty accounts associated with the user, wherein the loyalty accounts are determined by communicating with merchants providing the loyalty accounts, wherein the loyalty accounts are stored in association with the user identifier;
receiving a communication from a merchant comprising the user identifier, wherein the communication is part of transaction with the merchant;
matching, via a computer processing device, the user identifier communicated from the merchant with the loyalty accounts associated with the user identifier;
determining if the loyalty accounts associated with the user identifier received from the merchant are accepted by the merchant; and
providing the merchant with the loyalty accounts accepted by the merchant, such that the loyalty accounts can be applied to the transaction with the merchant.

18. The method of claim 17 further comprising:
determining coupons available to the user;
storing the coupons in association with the user identifier and the loyalty accounts;
determining coupons that the merchant of the transaction accepts; and
providing the merchant with the coupons acceptable by the merchant in association with the loyalty accounts accepted by the merchant, such that the coupons and loyalty accounts can be applied to the transaction with the merchant.

19. The method of claim 17, wherein the enrollment indication is automatically provided based at least in part on the user previously enrolling in another program, wherein the another program is provided by one or more of the merchant or a financial institution.

20. The method of claim 17, further comprising providing automatic enrollment in one or more loyalty accounts associated with the merchant if no loyalty accounts associated with the user identifier received from the merchant are accepted by the merchant.
